(19) United States
(12) Patent Application Publication
(10) Pub. No.: US 2011/0045795 A1
(43) Pub. Date: Feb. 24, 2011

(54) PORTABLE RADIO WITH AUTOMATIC MOTION SENSING AND EMERGENCY ALERT FACILITY

(76) Inventor: ERIC SACKNOFF, NEW YORK, NY (US)

Correspondence Address: Eric Sacknoff, 17 Wallace court, Rockville Centre, NY, 11570-4333, US

(21) Appl. No.: 12/543,572

(22) Filed: Aug. 19, 2009

(51) Int. Cl. G08B 21/00; H04M 11/04; G08B 1/08

(52) U.S. Cl. 455/404.1; 340/539.11; 340/669

(57) ABSTRACT

An apparatus and method comprising of a portable radio such as those carried by Firefighters and other First Responders and equipped with automatic motion sensing and Emergency Alert capabilities incorporated within the body of said portable radio which becomes activated when such Firefighters and other First Responders are unconscious or immobilized. The invention incorporates a motion sensing component, such as a Solid State Accelerometer interfaced with an orientation component, such as a Solid State Gyroscope, or a multidirectional solid State Accelerometer incorporated within the body of said portable radio and programmed to be activated by the wearer's motionlessness and subsequently provides the Emergency Alert as if the wearer had pressed the Emergency Alert button. The activation may send out an audible distress signal, a radio frequency (RF) distress signal, or both.

### FIELD OF THE INVENTION

The present invention relates generally to the field of emergency alert systems and more particularly relates to a portable radio equipped with Emergency Alert capabilities and motion sensing capabilities for automatically detecting a state of motionlessness and providing Emergency Alert to others when the wearer of the device has become immobilized or incapacitated.

### BACKGROUND OF THE INVENTION

Prompt recovery of an incapacitated or trapped person, such as a Firefighter, or other First Responder requires rapid notification that the person has been trapped or incapacitated, as well as rapid location of the person. Hence it has long been recognized for the need for some sort of a signaling device to be activated when a Firefighter becomes trapped or unconscious.

There are a variety of motion detectors known in the art to detect movement of the person, and which would be suitable for use as part of the rescue device. Many of these motion detectors monitor the acceleration of an element thereof and, from this, deduce the state of movement of the device using the electronic sensing devices such as accelerometers and gyroscopes. The accelerometer senses the linear acceleration in multiple directions, from which calculations such as velocity, direction and position can be derived. The Gyroscope senses an angular orientation of the wearer and outputs angular orientation data based on the sensed angular orientation. A multidirectional Accelerometer senses linear acceleration in multiple directions and gravitational orientation.

Many Firefighter and other First Responder radios come equipped with an Emergency Alert Button. This button may be found on the radio body only or both the radio body and remote microphone (the remote microphone is attached to the main radio body by a short cord and is usually worn on the chest, shoulder or collar area for easier transmissions). Activation of the Emergency Alert is achieved by depressing one of the provided buttons. The activation may send out an audible distress signal, a Radio Frequency (RF) distress signal, or both. The RF distress signal may be transmitted at a higher wattage and contain specific information about the identity of the sender.

A shortcoming in the Radio Frequency distress system is found when a Firefighter, other First Responder, or any wearer of a portable radio containing an Emergency Alert button suddenly becomes incapacitated or unconscious. In such a situation the radio's Emergency Alert button will not be activated and hence no alerting signal, either audible or radio frequency, shall be transmitted.

National Fire Protection Association standards require a passive device to be installed in all compliant air packs. These motion sensors, when activated, send out a generic audible alarm. The alarm is akin to a siren that provides a general alert only to those within audible range. The alarm may alert would-be rescuers but fails to identify the sender and fails to send an RF (radio frequency) signal.

There is a need for some sort of a radio frequency signaling device to be activated when a Firefighter, or other First Responder, or any wearer of a portable radio containing an Emergency Alert Button feature becomes trapped or unconscious.

The relevant prior art methods, which will deal with Emergency Alert Radios, are as follows:

U.S. Pat. No. 4,926,496 provides for digital mobile radio transceiver allows even the most unsophisticated user to simply and easily obtain emergency communications.

U.S. Pat. No. 5,742,904 describes a subscriber unit operating within a first communication system receives emergency alarm support from a second, operationally independent, communication system, that provides support through a guest access mode. The subscriber unit transmits a message to the second system, the message including the emergency alarm call and supplementary information that identifies the source of the emergency alarm call. The second system receives the message, determines source identification information for the emergency alarm call, and communicates the emergency alarm call to the first system based on the source identification information.

U.S. Pat. No. 5,917,887 details an emergency alert communication system comprising a radio frequency receiver. The radio frequency receiver decodes incoming emergency alert signals and demodulates data header signals and emergency alert voice message signals of the emergency alert signals. Included in the data header signals are event and location code signals, which are followed by the emergency alert voice message signals.

U.S. Pat. No. 6,990,329 disclose at least one of voice and data information is transmitted in connection mode via a radio interface in first radio zones. In second radio zones, voice or data information is transmitted exclusively in packet mode via a radio interface. When an emergency call is issued by a subscriber station from one of the first radio zones, a voice and/or data connection is established between the subscriber station and an emergency control center. When an emergency call is issued by a subscriber station from one of the second radio zones, at least one piece of emergency information which identifies the second radio zone is transmitted to an emergency control center.

U.S. Pat. No. 7,310,500 details an emergency button of a radio communication apparatus has been turned ON and a transmit mode button has been depressed, an MCU sets frequencies of a receiving section and a transmitting section to an emergency communication frequency. The MCU also causes an indicator lamp 10 to illuminate or flash at peak intensity, and causes a burst sound to be supplied from a loudspeaker at the maximum volume.

U.S. Pat. No. 7,394,360 claims a method for commissioning radio-based emergency alarm systems, having a master station) with a transmit and receive arrangement and peripheral elements.

U.S. Pat. No. 4,020,477 provides for a radio central station alarm system including a central station and a plurality of remote stations for transmitting alarm signals to the central station by means of radio signals. Alarm signals are transmitted repeatedly in a sequence which reduces the probability that signals transmitted by one remote station will be completely obscured by signals transmitted by other remote stations.

U.S. Pat. No. 5,430,433 describes a radio analog sensor for transmitting analog signals of a temperature or smoke density to a remote place by radio is used as each of sub devices 12-1 to 12-n. When a change of the analog detection signals of a temperature, a smoke density or the like, which is detected by the analog sensor 10 connected to each of the sub devices, is greater than a predetermined value, the analog signals which have been so far stored in a memory are collectively transmitted to the receiver side by radio. Periodic information is also sent from each of the sub devices 12-1 to 12-n once every two hours so as to supervise the state of the sensors. This permits reliable transmission of necessary data to a remote place without decreasing the life of the battery.

U.S. Pat. No. 4,864,277 claims an alarm system, particularly a radio transmitter alarm system in which an alarm condition causes the propulsion of an alerting radio transmitter to a high altitude, thereby significantly increasing the reliable working distance between a protected location and a staffed, alarm-receiving point.

The purpose and methodology of all the inventions that are part of prior art dealing with alarm systems and emergency calls and do not envisage the unique embodiment of the use of a motion sensor in a portable radio with Emergency Alert capabilities. The prior art does not address the issue of what happens when a Firefighter or other First Responder suddenly becomes incapacitated or unconscious. None of the above patents claims a motion sensor affixed to a portable radio that can detect a state of non motion and trigger an alarm.

Hence, there is a need for a portable device to sense and capture the user's motionlessness and provide notice of his incapacitation to others as well as aid in quickly and precisely locating the incapacitated person while he is being concealed by smoke or other natural elements or caught in fire or other agents which block direct viewing of the user of the device.

The present invention differs from the existent prior art in that it seeks to provide a novel portable radio equipped with an automatic, motionlessness/orientation sensor and Emergency Alert facilities, such that if the wearer is motionless for a preset time interval, the Emergency Alert alarm will be activated and function as if the wearer physically activated the alarm.

The present invention thus closes a fatal gap in providing the fastest and most far-reaching automatic signaling system for an unconscious or incapacitated Firefighter or other First Responder. The invention is incorporated into the portable radio normally carried by such Firefighter or other First Responder. The present invention is thus designed for use in a portable radio, self-powered by portable battery, and intended for personal use by a single individual. When no motion is detected for a preset time interval, an alarm signal is generated. If the motionlessness of the user is not due to a state of incapacitation or unconsciousness, the alarm may be manually de-activated by the user. The activation may send out an audible distress signal, an RF distress signal, or both. The RF distress signal may be transmitted at a higher wattage and contain specific information about the identity of the sender.

Further, it will be apparent to those skilled in the art that the objects of this invention have been achieved by providing a portable radio equipped with Emergency Alert and motion sensing capabilities for automatically detecting a state of motionlessness and providing Emergency Alert to others. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This present invention may be summarized, at least in part, with reference to its objects.

The foremost object of the present invention is to provide a novel motion sensing and Emergency Alert portable radio that can be carried by firefighters and other First Responders, to detect the motionlessness/orientation of the user.

Another object of the present invention is to provide a novel motion sensing and Emergency Alert portable radio that can be automatically activated when the user becomes unconscious or incapacitated and provide notice to others through the incorporated Emergency Alert feature.

Another object of the present invention is to provide a novel motion sensing and Emergency Alert portable radio that can provide a highly audible alarm to enable rescue operation, whereby the immobilized or incapacitated user can be located easily by the rescuers.

Another object of the present invention is to provide a novel motion sensing and Emergency Alert portable radio that possesses various sensitivities for physically canceling an alarm sequence.

Another object of the present invention is to provide a novel motion sensing and Emergency Alert portable radio that provides an audible pre-alarm warning signal.

Another object of the present invention is to provide a novel motion sensing and Emergency Alert portable radio that consists of various time frames for activation of both pre-alarm and full alarm modes.

Another object of the present invention is to provide a novel motion sensing and emergency alert portable radio that contains physical orientation/activation interface settings.

In accordance with the foregoing, the invention comprises of a portable radio equipped with automatic motion/orientation sensing and Emergency Alert capabilities. In an embodiment of this invention the motion sensor in the portable radio includes a Solid State Accelerometer interfaced with a Solid State Gyroscope or a multidirectional Solid State Accelerometer and is geared toward portable radios. When the Firefighter or other First Responder becomes unconscious or incapacitated, the Solid State Accelerometer becomes activated by the wearer's motionlessness and subsequently activates the Emergency Alert on the portable radio as if the wearer pressed the Emergency Alert button themselves. Timed delay of motionlessness sensing may be correlated to various orientations: For example, the Solid State Accelerometer may be programmed to alarm for a state of motionlessness which the Solid State Gyroscope (or multidirectional accelerometer) determines to be vertical, in a time frame that is greater than that as determined by the Solid State Gyroscope (or multidirectional accelerometer) for when the radio is in the horizontal plane, correlating to a wearer being generally standing versus laying.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction with the accompanying drawings listed below.

### DETAILED DESCRIPTION OF THE INVENTION

The following description is presented to enable any person skilled in the art to make and use the invention, and is provided in the context of particular applications of the invention and their requirements. The present invention can be configured as follows:

The present invention consists of a portable radio possessing automatic, motion sensing/orientation capabilities suitable for use by Firefighters, other First Responders and other suitable wearers. The portable radio shall function utilizing assigned radio frequencies and may be generated in an analog or digital mode. The said portable radio shall have ‘Emergency Alert’ or distress capabilities that shall previously only have been activated via physical means, i.e. utilization of a dedicated switch, button etc.

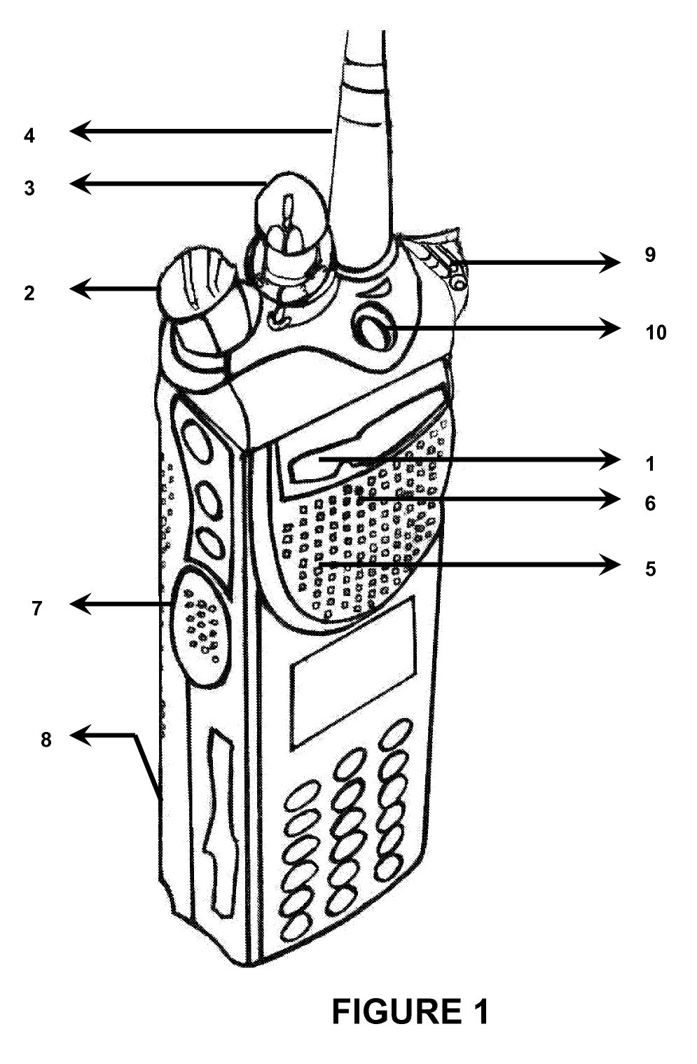

FIG. 1 is a perspective view of the portable radio comprising of the various components including the radio body with solid state accelerometer and solid state gyroscope or a multidirectional Solid State Accelerometer (1), on-off, volume control (2), channel selector knob (3), antenna (4), speaker (5), microphone (6), push-to-talk button (7), battery (8), attachment point for remote microphone (9) and an emergency alert button (10).

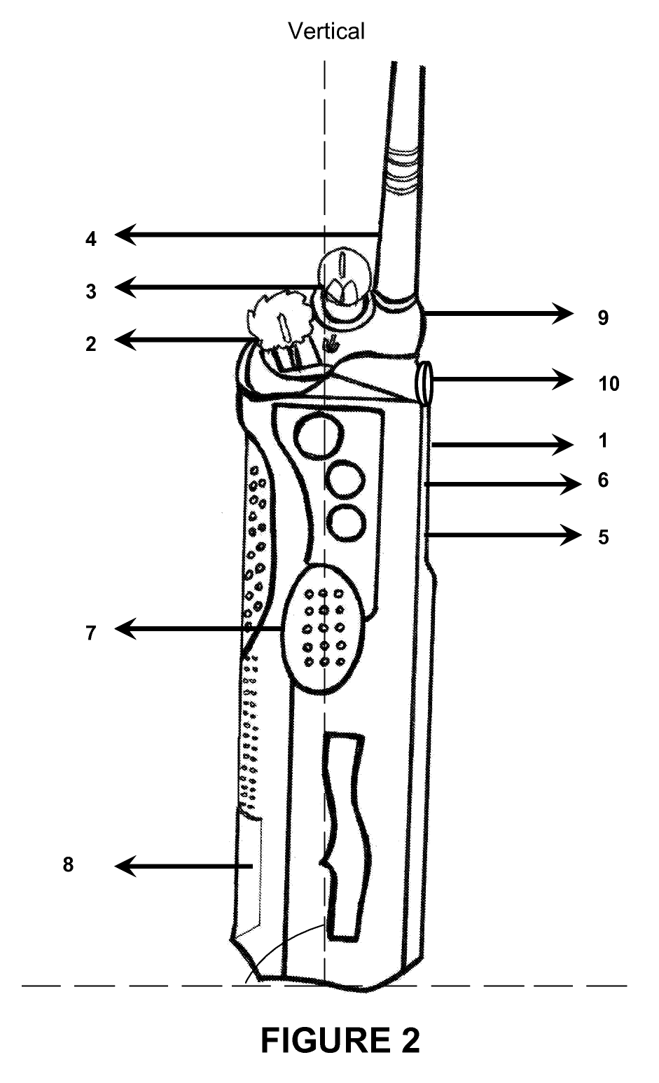

FIG. 2 is a perspective view of the portable radio with the longitudinal axis in the vertical plane.

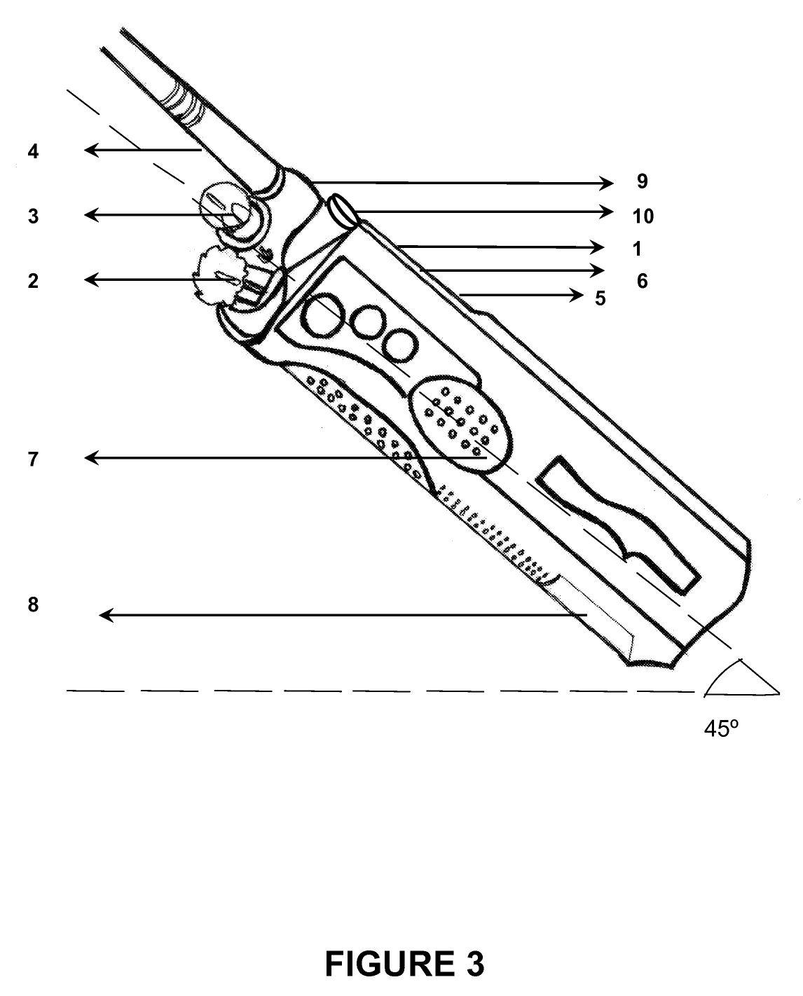

FIG. 3 is a perspective view of the portable radio placed at a 45 degree angle away from the vertical with designation relating to its longitudinal axis.

In an embodiment of this invention, the above said motion sensing device incorporates a Solid State Accelerometer and a Solid State Gyroscope or a multidirectional Solid state Accelerometer (1) within the body of the radio. Thus Motion/orientation sensing capabilities shall be incorporated into the body of the radio and be powered by same supply. The Motion sensing capabilities shall be achieved through use of a Solid State Accelerometer (1) (or similar) and the orientation sensing capabilities shall be achieved through us of a Solid State Gyroscope (1) (or similar), both incorporated within the body of the portable radio. The accelerometer (1) may interface with the gyroscope (1) either physically or electronically (or a multidirectional accelerometer may be used) and is installed so as to interface with the transmission feature of the radio's Emergency Alert button (10). The Motion sensor shall have programmable features for both time delay and orientation. i.e. the sensor shall activate after 100 seconds of non-movement when device is oriented in the vertical plane and activate after 30 seconds of non-movement when in the horizontal plane.

The accelerometer (1) senses the linear acceleration in multiple directions, from which calculations such as velocity, direction and position can be derived. The gyroscope (1) senses an angular velocity of the radio from which orientation may be determined. A multidirectional accelerometer will sense linear acceleration to determine velocity and utilize gravitational orientation to determine position. When the wearer becomes unconscious or incapacitated, the Solid State Accelerometer (1) becomes activated by the wearer's motionlessness and subsequently activates the Emergency Alert as if the wearer pressed the Emergency Alert button (10) themselves.

In another embodiment of this invention, the Solid State Accelerometer or multidirectional Solid State Accelerometer (1) incorporated within the body of the portable radio shall be programmable for various Motion-Sensing sensitivities.

In another embodiment of this invention, the Solid State Accelerometer or multidirectional Solid State Accelerometer (1) incorporated within the body of the portable radio can activate an audible Pre-Alarm warning signal.

In another embodiment of this invention, the Solid State Accelerometer or multidirectional Solid State Accelerometer (1) incorporated within the body of the portable radio shall be programmable for various time frames for activation of both pre-alarm and full alarm modes. Motion sensor activation shall entail an alarm sequence of an audible pre-alarm mode, giving the wearer time to cancel the alarm, and then a full-alarm mode, which will activate the ‘Emergency Alert’ or ‘Distress’ signal the same as if the wearer physically activated the ‘Emergency Alert’ switch or button (10).

In another embodiment of this invention, the Solid State Accelerometer/Gyroscope or multidirectional Solid State Accelerometer (1) incorporated within the body of the portable radio shall be programmed to provide physical orientation/activation interface settings. Motion sensor activation shall electronically tie-in to the physical activation process (button, switch) automatically and passively.

In another embodiment of this invention, the Solid State Accelerometer or multidirectional Solid State Accelerometer (1) incorporated within the body of the portable radio shall be programmed to offer various sensitivities for physically canceling an alarm sequence while in the pre-alarm mode, via movement of the device, i.e. shaking or tapping.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A portable radio with automatic motion and orientation sensing and emergency alert facility comprising of a motion/orientation sensing device incorporated within the body of said radio and powered by same supply characterized in that said motion/orientation sensing device includes but is not limited to a Solid State Accelerometer and a Solid State Gyroscope or a multidirectional Solid state Accelerometer (1).

2. The portable radio as claimed in claim 1 wherein said portable radio shall function utilizing assigned radio frequencies and may be generated in an analog or digital mode.

3. The portable radio as claimed in claim 1 wherein said radio shall have an manually activated Emergency Alert button (10).

4. The portable radio as claimed in claim 1 wherein said Solid State Accelerometer and Solid State Gyroscope and/or said multidirectional Solid State Accelerometer (1) are installed within the body of said portable radio so as to interface with the transmission feature of said Emergency Alert button (10)

5. The portable radio as claimed in claim 1 wherein said Solid State Accelerometer and/or said multidirectional Solid State Accelerometer (1) senses the linear acceleration in multiple directions and determines velocity of said radio.

6. The portable radio as claimed in claim 1 wherein said Solid State Accelerometer and/or said multidirectional Solid State Accelerometer (1) senses the linear acceleration in multiple directions and determines direction and/or gravitational orientation of said radio.

7. The portable radio as claimed in claim 1 wherein said Solid State Gyroscope and/or said multidirectional Solid State Accelerometer (1) senses axial relationships in multiple directions and determines orientation of said radio.

8. The portable radio as claimed in claim 1 wherein said Solid State Accelerometer and said Solid State Gyroscope and/or said multidirectional Solid State Accelerometer (1) have programmable features for time delay that are activated by combinational variables of time and orientation such that the Emergency Alert (10) shall be electronically activated after a set amount of motionlessness when the longitudinal axis of the radio is oriented in the vertical plane.

9. The portable radio as claimed in claim 1 wherein said Solid State Accelerometer and said Solid State Gyroscope and/or said multidirectional Solid State Accelerometer (1) have programmable features for time delay that are activated by combinational variables of time and orientation such that the Emergency Alert button (10) shall be electronically activated after a set amount of motionlessness when the longitudinal axis of the radio is oriented equal or greater than a set number of degrees away from the vertical plane.

10. The portable radio as claimed in claim 1 wherein said Solid State Gyroscope (1) senses the linear acceleration in multiple directions and determines angular velocity of said portable radio.

11. The portable radio as claimed in claim 1 wherein said Solid State Accelerometer and/or said multidirectional Solid State Accelerometer (1) attains an activation threshold by calculating direction, position, velocity and angular velocity of said radio.

12. The portable radio as claimed in claim 1 wherein activation threshold of said Solid State Accelerometer and/or said multidirectional Solid State Accelerometer (1) triggers an alarm sequence of an audible pre-alarm mode, giving the wearer time to cancel the alarm.

13. The portable radio as claimed in claim 1 wherein activation threshold of said Solid State Accelerometer and/or said multidirectional Solid State Accelerometer (1) triggers an alarm sequence of a full-alarm mode same as manually activating said Emergency Alert button (10).

14. The portable radio as claimed in claim 1 wherein said Solid State Accelerometer and/or said multidirectional Solid State Accelerometer (1) is be programmable for various Motion-Sensing sensitivities.

15. The portable radio as claimed in claim 1 wherein said Solid State Accelerometer and/or said multidirectional Solid State Accelerometer (1) can activate an audible Pre-Alarm warning signaling.

16. The portable radio as claimed in claim 1 wherein said Solid State Accelerometer and/or said multidirectional Solid State Accelerometer (1) does not hinder physical activation of radio's Emergency Alert button (10).

17. The portable radio as claimed in claim 1 wherein said Solid State Accelerometer and/or said multidirectional Solid State Accelerometer (1) is programmed to offer various sensitivities for physically canceling an alarm sequence, while in the pre-alarm mode, via movement of said device by shaking or tapping.
